(19) United States
(12) Patent Application Publication
(10) Pub. No.: US 2015/0356518 A1
(43) Pub. Date: Dec. 10, 2015

(54) AGGREGATE TASK SYSTEM

(71) Applicant: Oracle International Corporation, Redwood Shores, CA (US)

(72) Inventors: Niladri DE, Hyderabad (IN); Srinivasu DUDALA, Hyderabad (IN); Mani Kumar Vran KASIBHATLA, Hyderabad (IN)

(21) Appl. No.: 14/300,725

(22) Filed: Jun. 10, 2014

(51) Int. Cl. G06Q 10/10; G06F 3/0481

(52) U.S. Cl. CPC G06Q 10/1097; G06F 3/0481

(57) ABSTRACT

A system is provided that manages tasks. The system defines an aggregate task including aggregate parts, where each aggregate part is an individual task that is a part of the aggregate task, and where the aggregate task defines a sequence of the aggregate parts. The system further displays the aggregate task and a project plan timeline within a user interface, where the aggregate task is displayed within the project plan timeline, and where the aggregate task is displayed as an aggregate task indicator including aggregate part indicators separated by dividers.

### FIELD

One embodiment is directed to a computer system, and more particularly, to a computer system that displays data.

### BACKGROUND

Project managers or planners typically work with a project plan timeline, which is a set of tasks that are associated with an overall project or objective, and that are displayed over a timeline. Project managers typically define the project plan timeline, and thus, typically define how tasks are distributed within the project plan timeline. A project can include significant number of very similar or identical loosely-affiliated individual tasks, where each task is considered too small or insignificant to be tracked (or becomes too cumbersome to track) individually. Some examples of these kinds of affiliated tasks are indicated below.

For construction of a building, constructing windows, fitting windows, and painting windows are all examples of affiliated tasks. This is because, for construction of a building, these tasks for individual windows are too small and insignificant, and become too cumbersome, to track in a project plan.

For making a software product, graphical design of icons, placement and coding for the icons, and testing the behavior of the icons, are all examples of affiliated tasks. This is because, for making a software product, these tasks for individual icons are too small and insignificant, and become too cumbersome, to track in a project plan.

For performing post-production editing during the making of a movie, both video editing and sound editing are examples of affiliated tasks. This is because it is not feasible or desirable to track the video editing and sound editing tasks for every particular movie sequence in the movie.

### SUMMARY

One embodiment is a system that manages tasks. The system defines an aggregate task including aggregate parts, where each aggregate part is an individual task that is a part of the aggregate task, and where the aggregate task defines a sequence of the aggregate parts. The system further displays the aggregate task and a project plan timeline within a user interface, where the aggregate task is displayed within the project plan timeline, and where the aggregate task is displayed as an aggregate task indicator including aggregate part indicators separated by dividers.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a system that can implement an embodiment of the invention.

FIG. 2 illustrates aggregate tasks and aggregate task dependencies, according to an embodiment of the invention.

FIG. 3 illustrates aggregate tasks and aggregate task dependencies with dependency multiplicities, according to an embodiment of the invention.

FIG. 4 illustrates a conversion of tasks to aggregate tasks, and a conversion of a task dependency to an aggregate part dependency, according to an embodiment of the invention.

FIG. 5 illustrates a flow diagram of the functionality of an aggregate task module, according to an embodiment of the invention.

### DETAILED DESCRIPTION

According to an embodiment, an aggregate task system is provided that defines, manages, and visualizes a new type of task for a project plan timeline, referred to as an “aggregate task.” An “aggregate task” is a task aggregation that includes a plurality of similar or identical individual tasks, which are identified as “task parts” or “aggregate parts.” The aggregate task system further defines, manages, and visualizes a new type of dependency for a project plan timeline, referred to as an “aggregate part dependency.” An “aggregate part dependency” is a dependency between aggregate parts of two distinct aggregate tasks. The aggregate task system can further execute dependent sequential tasks in a parallel manner. The aggregate task system can accomplish this by converting tasks into aggregate tasks, and by converting a task dependency between the two tasks into an aggregate part dependency between the two aggregate tasks.

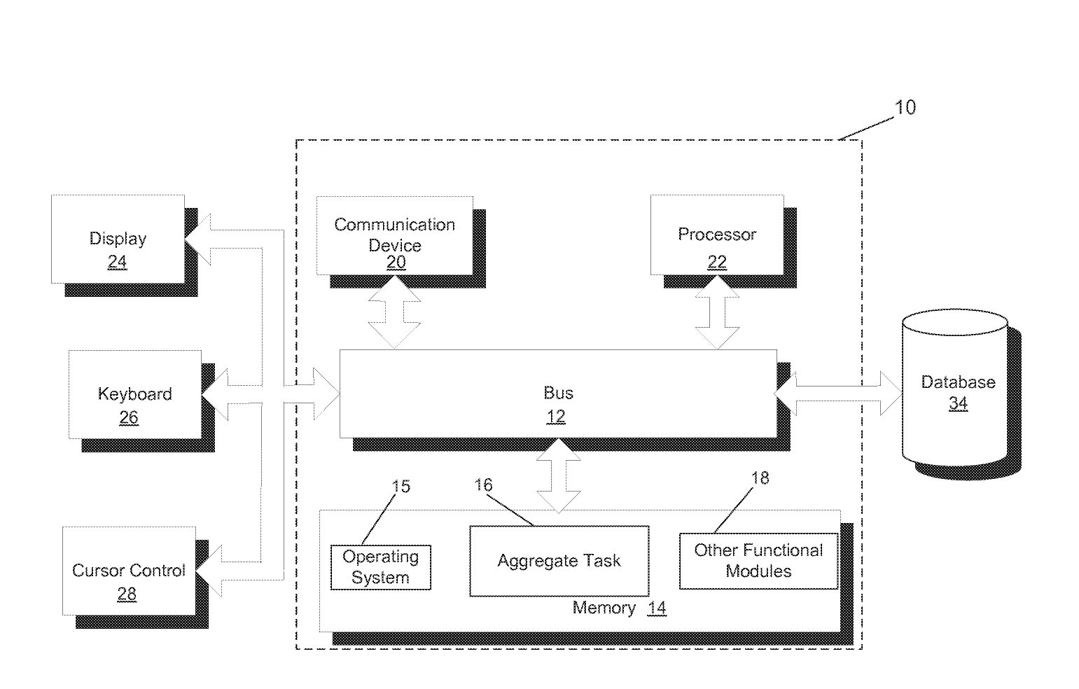

FIG. 1 illustrates a block diagram of a system 10 that can implement one embodiment of the invention. System 10 includes a bus 12 or other communications mechanism for communicating information between components of system 10. System 10 also includes a processor 22, operatively coupled to bus 12, for processing information and executing instructions or operations. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. System 10 further includes a communication device 20, such as a network interface card or other communications interface, to provide access to a network. As a result, a user may interface with system 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. A keyboard 26 and a cursor control device 28, such as a computer mouse, can also be operatively coupled to bus 12 to enable the user to interface with system 10.

According to one embodiment, memory 14 can store software modules that may provide functionality when executed by processor 22. The modules can include an operating system 15, an aggregate task module 16, as well as other functional modules 18. Operating system 15 can provide an operating system functionality for system 10. Aggregate task module 16 can provide functionality for defining, visualizing, and managing aggregate tasks and aggregate part dependencies among aggregate tasks, as further disclosed below. In certain embodiments, aggregate task module 16 can comprise a plurality of modules, where each module provides specific individual functionality for defining, visualizing, and managing aggregate tasks and aggregate part dependencies among aggregate tasks. System 10 can also be part of a larger system. Thus, system 10 can include one or more additional functional modules 18 to include the additional functionality. For example, functional modules 18 may include modules that provide additional functionality, such as functionality of a “Primavera Enterprise Project Portfolio Management” by Oracle Corporation.

Processor 22 can also be operatively coupled via bus 12 to a database 34. Database 34 can store data in an integrated collection of logically-related records or files. Database 34 can be an operational database, an analytical database, a data warehouse, a distributed database, an end-user database, an external database, a navigational database, an in-memory database, a document-oriented database, a real-time database, a relational database, an object-oriented database, or any other database known in the art.

As previously described, an aggregate task is a task aggregation that includes a plurality of similar or identical individual tasks (i.e., aggregate parts). With normal tasks, four different kinds of dependency relationships are possible: (1) finish-to-start dependency (successor task cannot start until predecessor task finishes); (2) finish-to-finish dependency (successor task cannot finish until predecessor task finishes); (3) start-to-start dependency (successor task cannot start until predecessor task starts); or (4) start-to-finish dependency (successor task cannot finish until predecessor task starts). For a dependency among two tasks, a predecessor task is the task whose start or finish date-time (i.e., date and/or time) drives a dependency condition, and a successor task is the task whose start or finish date-time is driven by the dependency condition.

Similar dependency relationships often exist between aggregate parts of two aggregate tasks. For example, fitting a window can only be started after the task of making the window has been finished. Thus, a finish-to-start dependency exists between aggregate parts. However, if an aggregate task had, for example, five aggregate parts, it would not be correct to say that the aggregate tasks themselves have a finish-to-start dependency. Because, in the example, the task of fitting the first of the five windows can start as soon as the task of making the first of the five windows has finished, and need not wait for all five windows to be made. In other words, in a scenario involving n windows, a task of fitting the m-th window can start as soon as the task of making the m-th window has finished (where m is less than or equal to n).

Additionally, there may be a need to define a dependency multiplicity at an aggregate part level on either or both sides of an aggregate part dependency. A dependency multiplicity indicates a number of aggregate parts of an aggregate task that depends on a different number of aggregate parts of another aggregate task. For example, every window fitting task can be dependent on two window pane making tasks. It is also desirable to be able to partition a large aggregate task into two or more smaller aggregate tasks, or merge two or more similar aggregate tasks into a larger aggregate task, and still be able to keep and/or reuse the already defined dependency relationships. Further, similar to a normal task, a successor aggregate task can have more than one predecessor aggregate tasks, and vice-versa. For example, both a task of painting a window and a task of fitting a window can be finish-to-start dependent successors of a predecessor task of making a window.

Current project management systems have severe difficulties in describing these kinds of dependency relationships. Some project management systems partition the aggregate tasks into individual tasks and define individual task dependencies between the individual tasks as if they were normal tasks. However, this approach becomes very cumbersome and difficult to manage, due to the sheer number of tasks and task dependencies. Other project management systems define a single set of tasks and task dependencies, and then replicate the single set of tasks and task dependencies an n number of times. While this approach simplifies the definition of tasks and task dependencies, this approach has the same limitations as the first approach regarding managing the tasks and task dependencies. Further, other project management systems group similar or identical individual tasks into summary tasks, and then define the dependencies at the summary level. However, a summary level dependency does not accurately describe the situation, because the dependency relationship is part-by-part, or incremental, rather than end-to-end. For example, it is not accurate to say that none of the task parts of a summary task can start until all summary task parts of another summary task finish. Thus, this approach can result in inaccurate/incorrect dependencies.

Thus, there can be a need to abstract similar or identical individual tasks into an aggregate task that includes multiple aggregate parts, and to manage the aggregate task, as well as any aggregate part dependencies, visually within a project plan timeline. There can also be a need to: (a) assign resources to aggregate parts; (b) identify aggregate part dependencies between aggregate parts and display aggregate part dependencies within a project plan timeline; and (c) access the aggregate tasks and aggregate part dependencies in a manner that is not too burdensome.

Thus, according to an embodiment, an aggregate task system can define a new type of task for a project plan timeline, an “aggregate task.” An “aggregate task” is a task aggregation that includes a plurality of similar or identical individual tasks, which are identified as “task parts” or “aggregate parts.” An aggregate task is different from a “summary task” of other project management systems (also identified as a “non-leaf task,” a “parent task,” or a “task group”). A summary task generally has several child tasks or subtasks. However, an aggregate task is a task itself, rather than having child tasks, and the aggregate task includes a plurality of aggregate parts. Further, a summary task typically has heterogeneous subtasks, while an aggregate task includes homogenous, or otherwise affiliated, aggregate parts (i.e., includes similar or identical aggregate parts). Additionally, the subtasks of a summary task typically do not have a strict time sequence. Instead, a summary task is typically a mere grouping of subtasks. In contrast, an aggregate task defines a sequence of its aggregate parts. Further, a summary task is usually represented within a user interface by a display of a thick line with two hanging markers at both ends, resembling a bracket. In contrast, an aggregate task can be displayed within a user interface as a rectangle, bar, box, or other aggregate task indicator. The aggregate task indicator can include a plurality of aggregate part indicators (e.g., rectangles) that represent the aggregate parts of the aggregate task, where the aggregate part indicators can be separated by dividers (e.g., dividing lines). Thus, an aggregate task can be displayed within the user interface using an indicator that is similar to other task indicators that represent tasks.

In addition, in accordance with an embodiment, an aggregate task system can define a new type of dependency for a project plan timeline, an “aggregate part dependency.” An “aggregate part dependency” is a dependency between aggregate parts of two distinct aggregate tasks. Thus, an aggregate part dependency is a dependency between aggregate parts of aggregate tasks, rather than the aggregate tasks themselves. An aggregate part dependency is similar to a task dependency of other project management systems, where a task dependency is a dependency between two normal tasks An aggregate part dependency can be one of: a finish-to-start dependency; a finish-to-finish dependency; a start-to-start dependency; or a start-to-finish dependency. As another example, for an aggregate part dependency between two aggregate tasks, a start or finish of an aggregate part of a predecessor aggregate task and a start or finish of an aggregate part of a successor aggregate task occur at a “substantially” identical date-time. What is meant by “substantially,” is that a start or finish of an aggregate part of a predecessor aggregate task occurs within a pre-defined threshold of a start or finish of an aggregate part of a predecessor aggregate task (i.e., within +ye and -ye, where “ye” represents a pre-defined threshold). Thus, a start or finish of an aggregate part of a predecessor aggregate task can occur before, after, or at the same time as, a start or finish of an aggregate part of a predecessor aggregate task, as long as the start or finish of an aggregate part of a predecessor aggregate task occurs within the pre-defined threshold of the start or finish of an aggregate part of a predecessor aggregate task.

However, an aggregate part dependency is also different from a task dependency of other project management systems. A task dependency is generally end-to-end (i.e., between a predecessor task and a successor task), whereas an aggregate part dependency is part-to-part (i.e., between an aggregate part of a predecessor aggregate task and an aggregate part of a successor aggregate task). For example, a finish-to-start aggregate part dependency between a predecessor aggregate task and a successor aggregate task means that a first aggregate part of the predecessor aggregate task has a finish-to-start dependency defined with a first aggregate part of the successor aggregate task, a second aggregate part of the predecessor aggregate task has a finish-to-start dependency defined with a second aggregate part of the successor aggregate task, etc.

Further, a task dependency is generally one-to-one (i.e., is defined between two tasks). However, an aggregate part dependency can be defined between two sets of aggregate parts, where a number of aggregate parts for a first set of aggregate parts is different that a number of aggregate parts for a second set of aggregate parts. For example, a predecessor aggregate task can have seven aggregate parts, and a successor aggregate task can have eight aggregate parts. In this example, the aggregate task having more aggregate parts (i.e., the successor aggregate task) will have one or more aggregate parts that do not depend on any corresponding aggregate parts of the predecessor aggregate task (in this example, the eighth aggregate part).

Additionally, an aggregate part dependency can produce a duration gap, or other type of spacing, between the aggregate parts of an aggregate task, if the aggregate parts of another aggregate task are of a longer duration than the aggregate parts of the aggregate task. For example, if every aggregate part of a predecessor aggregate task has a duration of two days, whereas every aggregate part of a successor aggregate task has a duration of one day, and if the predecessor aggregate task and the successor aggregate task are linked with an aggregate part dependency of a finish-to-start type, then the successor aggregate task will have one-day idle time spacing between its aggregate parts. This spacing can be identified as “stripe spacing.”

Further, an aggregate part dependency can have a dependency multiplicity defined at either end, or both ends. A dependency multiplicity indicates a number of aggregate parts of an aggregate task that depends on a different number of aggregate parts of another aggregate task. For example, every aggregate part of a successor aggregate task can be dependent on completion of two aggregate parts of a predecessor task. In this example, the aggregate part dependency has a dependency multiplicity of 2-to-1.

In addition, a task dependency is usually represented within a user interface with a task dependency indicator, where a task dependency indicator is typically displayed within the user interface as a single-line arrow between two task indicators that represent two tasks (where the two task indicators are typically displayed as rectangles, bars, or boxes). In contrast, an aggregate task dependency can be represented within a user interface with an aggregate task dependency indicator, where the aggregate task dependency indicator can be displayed within the user interface as a multi-line arrow between two aggregate tasks. This is only an example embodiment, and in other embodiments, an aggregate task dependency indicator can be displayed within the user interface using another type of representation.

Further, stripe spacing within an aggregate task can be displayed as a distinct portion of the aggregate task indicator that is shaded differently (such as with dots). This is to assist a user in visually distinguishing regions within the aggregate task indicator where actual aggregate parts are scheduled as compared to regions where idle periods are scheduled. This is only an example embodiment, and in other embodiments, stripe spacing can be displayed within the user interface using another type of representation.

In addition, when an aggregate part dependency includes a dependency multiplicity (or a plurality of dependency multiplicities), one or more dependency multiplicity indicators can be displayed within a user interface. A dependency multiplicity indicator can be displayed as a number within the user interface, where the number represents the dependency multiplicity (e.g., “2” representing a dependency multiplicity of 2). This is to assist a user visually identify a cardinality of the aggregate parts from both sides that are part of an aggregate part dependency relationship. This is only an example embodiment, and in other embodiments, a dependency multiplicity indicator can be displayed within the user interface using another type of representation.

Further, when an aggregate task associated with an aggregate part dependency has fewer aggregate parts (after considering any dependency multiplicities, if specified) than another aggregate task associated with the aggregate part dependency, a display of a portion of an aggregate part dependency indicator can be modified within the user interface. For example, where the aggregate part dependency indicator is a multi-line arrow, a portion of the multi-line arrow that is closest to an aggregate task indicator that represents the aggregate task with the fewer number of aggregate parts can be displayed as a dashed multi-line arrow. This is only an example embodiment, and in other embodiments, another modification of the aggregate part dependency indicator, such as a deficiency part indicator, can be displayed within the user interface using another type of representation.

In addition, there can be situations where there are two sequentially dependent tasks (e.g., two tasks with a finish-to-start dependency), and there is also an urgency for the two tasks to be completed. In other words, there is a need for some parts of the two tasks to be performed in parallel. Previous project management systems typically required a user to manually split the tasks into multiple task parts, and allow a task part of the successor task to be started as soon as a task part of the predecessor task finished. However, in accordance with an embodiment, an aggregate task system can convert two sequentially dependent tasks into aggregate tasks, and can convert a task dependency between the two tasks into an aggregate part dependency between the two aggregate tasks. This can eliminate the requirement of manually splitting tasks and manually creating individual dependencies between task parts.

In some embodiments, the aggregate task system can be part of an overall system, such as a project management system, where the system includes a scheduling mechanism that can schedule defined tasks, and that can assign resources to and from defined tasks. In these embodiments, the scheduling mechanism can be aware of any aggregate task definitions as well as any aggregate part dependency definitions, so that the scheduling mechanism can schedule any aggregate tasks accordingly. For example, after defining a finish-to-start aggregate part dependency between two aggregate tasks, the scheduling mechanism may need to be able to adjust start date-times and finish date-times of all aggregate parts of a successor aggregate task such that a finish-to-start dependency relationship is maintained between every pair of aggregate parts. This may include an adjustment of a start date-time and a finish date-time of the successor aggregate task as well as any stripe spacing, as appropriate. Thus, the scheduling mechanism can be modified to identify every aggregate part individually, and also identify a corresponding dependency relationship between every individual pair of aggregate parts.

Further, in some embodiments, two aggregate tasks can have both a task dependency relationship and an aggregate part dependency relationship. For example, two aggregate tasks can have a task dependency relationship of a finish-to-finish type, and also can have an aggregate part dependency relationship of a finish-to-start type. Task dependency relationships specify end-to-end relationship, whereas aggregate part dependency relationships specify part-to-part relationships.

In some embodiments, the aggregate task system can allow a user to convert a task to an aggregate task by receiving a number of parts as input. When converting a task to an aggregate task, the aggregate task system can leave all dependencies connected to the task unmodified. However, when converting an aggregate task to a task, the aggregate task system can convert all aggregate part dependencies for the aggregate task to a single task dependency.

Further, in some embodiments, the aggregate task system can allow a user to convert a task dependency to an aggregate part dependency if both sides of the task dependency are aggregate tasks. The aggregate task system can further allow a user to convert an aggregate part dependency to a task dependency. When converting an aggregate part dependency to a task dependency, the aggregate task system can readjust any stripe spacing displayed within an aggregate task indicator that represents a successor aggregate task.

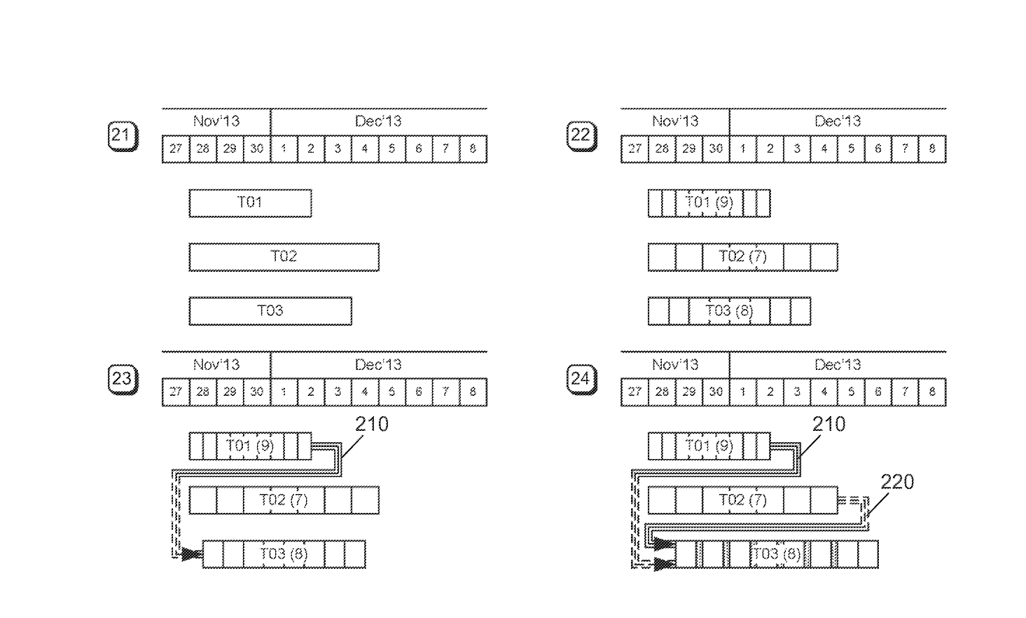

FIG. 2 illustrates aggregate tasks and aggregate task dependencies, according to an embodiment of the invention. More specifically, FIG. 2 illustrates a project plan 21 displayed by an aggregate task system, such as system 10 of FIG. 1. Project plan 21 includes tasks T01, T02, and T03. Tasks T01, T02, and T03 are displayed within a timeline that is displayed within a user interface. More specifically, task indicators (bars in the illustrated embodiment) are displayed within the user interface, where the task indicators represent tasks T01, T02, and T03. In the illustrated embodiment, the task indicators that represent tasks T01, T02, and T03 include task name labels. Task T01 has a duration of 4.5 days, a start date-time of November 28 (start-of-day) and a finish date-time of December 2 (mid-day). Task T02 has a duration of 7 days, a start date-time of November 28 (start-of-day) and a finish date-time of December 4 (end-of-day). Task T03 has a duration of 6 days, a start date-time of November 28 (start-of-day) and a finish date-time of December 3 (end-of-day).

FIG. 2 further illustrates a project plan 22 displayed by an aggregate task system. Project plan 22 is similar to project plan 21, except that, within project plan 22, the aggregate task system has converted tasks T01, T02, and T03 into aggregate tasks T01, T02, and T03. As part of the conversion, aggregate task T01 has been partitioned so that aggregate task T01 includes nine aggregate parts, aggregate task T02 has been partitioned so that aggregate task T02 includes seven aggregate parts, and aggregate task T03 has been partitioned so that aggregate task T03 includes eight aggregate parts. Aggregates tasks T01, T02, and T03 are displayed within a timeline that is displayed within a user interface. More specifically, aggregate task indicators (bars with respective dividers in the illustrated embodiment) are displayed within the user interface, where the aggregate task indicators represent aggregate tasks T01, T02, and T03. In the illustrated embodiment, the aggregate task indicators that represent aggregate tasks T01, T02, and T03 include aggregate task name labels that include the number of aggregate parts.

FIG. 2 further illustrates a project plan 23 displayed by an aggregate task system. Project plan 23 is similar to project plan 22, except that, within project plan 23, the aggregate task system has defined an aggregate part dependency 210 between aggregate task T01 and aggregate task T03, where aggregate part dependency 210 is a finish-to-start dependency. Aggregate part dependency 210 is displayed within a timeline that is displayed within the user interface. More specifically, an aggregate part dependency indicator is displayed within the user interface, where the aggregate part dependency indicator represents aggregate part dependency 210. In the illustrated embodiment, the aggregate part dependency indicator is a multi-line arrow that connects the aggregate task indicator that represents aggregate task T01 (i.e., the predecessor aggregate task) and the aggregate task indicator that represents aggregate task T03 (i.e., the successor aggregate task), where an arrow head of the multi-line arrow points towards the aggregate task indicator that represents aggregate task T03. Further, in the illustrated embodiment, a portion of the multi-line arrow that is adjacent or closest to the aggregate task indicator that represents aggregate task T03 is a dashed multi-line arrow rather than a solid multi-line arrow. This visually indicates that aggregate task T03 has fewer aggregate parts than aggregate task T01. Additionally, the start date-time of aggregate task T03 has been adjusted by 0.5 days from November 28 (start-of-day) to November 28 (mid-day), so that the first aggregate part of aggregate task T03 is scheduled to start on or after a scheduled finish of the first aggregate part of aggregate task T01. The adjustment of the start date-time results in aggregate task T03 starting 0.5 days later than originally scheduled in project plan 22. In certain embodiments, the first aggregate part of aggregate task T03 can start at a date-time that is substantially identical to a date-time that the first aggregate part of aggregate task T01 finishes.

FIG. 2 further illustrates a project plan 24 displayed by an aggregate task system. Project plan 24 is similar to project plan 23, except that, within project plan 24, the aggregate task system has defined an aggregate part dependency 220 between aggregate task T02 and aggregate task T03, where aggregate part dependency 220 is a finish-to-start dependency. Aggregate part dependency 220 is displayed within a timeline that is displayed within the user interface. More specifically, an aggregate part dependency indicator is displayed within the user interface, where the aggregate part dependency indicator represents aggregate part dependency 220. In the illustrated embodiment, the aggregate part dependency indicator is a multi-line arrow that connects the aggregate task indicator that represents aggregate task T02 (i.e., the predecessor aggregate task) and the aggregate task indicator that represents aggregate task T03 (i.e., the successor aggregate task), where an arrow head of the multi-line arrow points towards the aggregate task indicator that represents aggregate task T03. Further, in the illustrated embodiment, a portion of the multi-line arrow that is adjacent or closest to the aggregate task indicator that represents aggregate task T02 is a dashed multi-line arrow rather than a solid multi-line arrow. This visually indicates that aggregate task T02 has fewer aggregate parts than aggregate task T03. Additionally, the start date-time of aggregate task T03 has been adjusted by 0.5 days from November 28 (mid-day) to November 29 (start-of-day), so that the first aggregate part of aggregate task T03 is scheduled to start at or after a scheduled finish of the first aggregate part of aggregate task T02. The adjustment of the start date-time results in aggregate task T03 starting 0.5 days later than previously scheduled in project plan 23 (and starting 1 day later than originally scheduled in project plan 22). In certain embodiments, the first aggregate part of aggregate task T03 can start at a date-time that is substantially identical to a date-time that the first aggregate part of aggregate task T02 finishes. Further, because a duration of each aggregate part of aggregate task T02 (i.e., 1 day) is larger than a duration of each aggregate part of aggregate task T03 (i.e., 0.75 days), idle periods are created within aggregate task T03, where an idle period represents a period where a successor aggregate task is awaiting one or more aggregate parts of a predecessor aggregate task to either start or finish. These idle periods can be represented within the aggregate task indicator that represents aggregate task T03 by automatically displaying stripe spacing within the aggregate task indicator. In the illustrated embodiment, portions of the aggregate task indicator that represent the idle periods within aggregate task T03 are shaded with dots. Further, an idle period is not created between the last two aggregate parts of aggregate task T03. This is because, since aggregate task T02 only has seven parts, the eighth part of aggregate task T03 does not depend on anything, and can be started as soon as the seventh part of aggregate task T03 has finished.

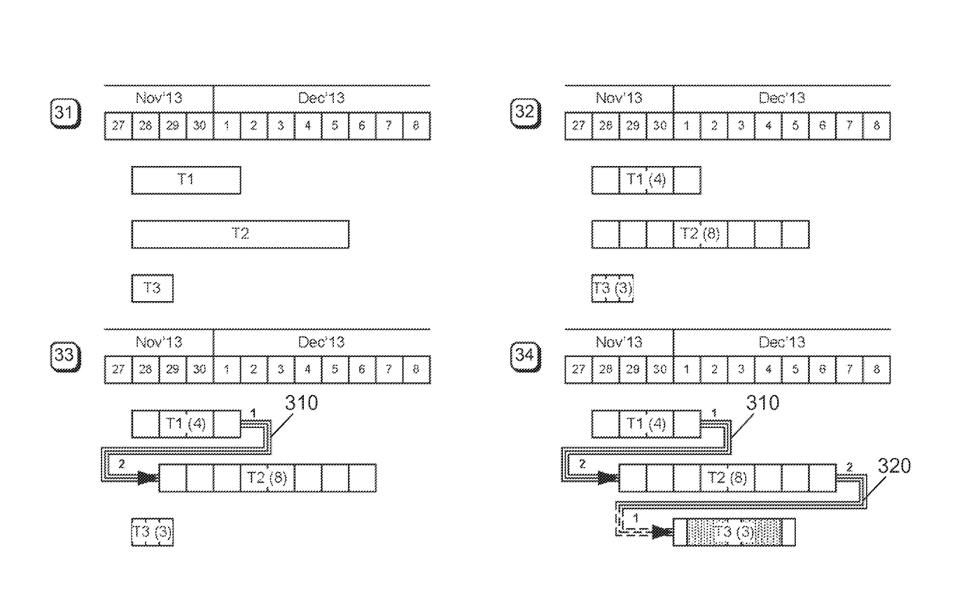

FIG. 3 illustrates aggregate tasks and aggregate task dependencies with dependency multiplicities, according to an embodiment of the invention. More specifically, FIG. 3 illustrates a project plan 31 displayed by an aggregate task system, such as system 10 of FIG. 1. Project plan 31 includes tasks T1, T2, and T3. Tasks T1, T2, and T3 are displayed within a timeline that is displayed within a user interface. More specifically, task indicators (bars in the illustrated embodiment) are displayed within the user interface, where the task indicators represent tasks T1, T2, and T3. In the illustrated embodiment, the task indicators that represent tasks T1, T2, and T3 include task name labels. Task T1 has a duration of 4 days, a start date-time of November 28 (start-of-day) and a finish date-time of December 1 (end-of-day). Task T2 has a duration of 8 days, a start date-time of November 28 (start-of-day) and a finish date-time of December 5 (end-of-day). Task T3 has a duration of 1.5 days, a start date-time of November 28 (start-of-day) and a finish date-time of November 29 (mid-day).

FIG. 3 further illustrates a project plan 32 displayed by an aggregate task system. Project plan 32 is similar to project plan 31, except that, within project plan 32, the aggregate task system has converted tasks T1, T2, and T3 into aggregate tasks T1, T2, and T3. As part of the conversion, aggregate task T1 has been partitioned so that aggregate task T1 includes four aggregate parts, aggregate task T2 has been partitioned so that aggregate task T2 includes eight aggregate parts, and aggregate task T3 has been partitioned so that aggregate task T3 includes three aggregate parts. Aggregates tasks T1, T2, and T3 are displayed within a timeline that is displayed within a user interface. More specifically, aggregate task indicators (bars with respective dividers in the illustrated embodiment) are displayed within the user interface, where the aggregate task indicators represent aggregate tasks T1, T2, and T3. In the illustrated embodiment, the aggregate task indicators that represent aggregate tasks T1, T2, and T3 include aggregate task name labels that include the number of aggregate parts.

FIG. 3 further illustrates a project plan 33 displayed by an aggregate task system. Project plan 33 is similar to project plan 32, except that, within project plan 33, the aggregate task system has defined an aggregate part dependency 310 between aggregate task T1 and aggregate task T2, where aggregate part dependency 310 is a finish-to-start dependency. Aggregate part dependency 310 is displayed within a timeline that is displayed within the user interface. More specifically, an aggregate part dependency indicator is displayed within the user interface, where the aggregate part dependency indicator represents aggregate part dependency 310. In the illustrated embodiment, the aggregate part dependency indicator is a multi-line arrow that connects the aggregate task indicator that represents aggregate task T1 (i.e., the predecessor aggregate task) and the aggregate task indicator that represents aggregate task T2 (i.e., the successor aggregate task), where an arrow head of the multi-line arrow points towards the aggregate task indicator that represents aggregate task T2. Further, aggregate part dependency 310 has a dependency multiplicity of 1-to-2. In other words, every aggregate part of aggregate task T1 has a finish-to-start dependency with two aggregate parts of aggregate task T2, where the aggregate parts of aggregate task T1 are the predecessor aggregate parts, and where the aggregate parts of aggregate task T2 are the successor aggregate parts. Thus, a dependency multiplicity indicator is displayed adjacent to a portion of the multi-line arrow that is adjacent or closest to the aggregate task indicator that represents aggregate task T1 (“1” in the illustrated embodiment). Further, a dependency multiplicity indicator is also displayed adjacent to a portion of the multi-line arrow that is adjacent or closest to the aggregate task indicator that represents aggregate task T2 (“2” in the illustrated embodiment). Additionally, the start date-time of aggregate task T2 has been adjusted by 1 day from November 28 (start-of-day) to November 29 (start-of-day), so that the first aggregate part of aggregate task T2 is scheduled to start at or after a scheduled finish of the first aggregate part of aggregate task T1. The adjustment of the start date-time results in aggregate task T2 starting 1 day later than originally scheduled in project plan 32. In certain embodiments, the first aggregate part of aggregate task T2 can start at a date-time that is substantially identical to a date-time that the first aggregate part of aggregate task T1 finishes.

FIG. 3 further illustrates a project plan 34 displayed by an aggregate task system. Project plan 34 is similar to project plan 33, except that, within project plan 34, the aggregate task system has defined an aggregate part dependency 320 between aggregate task T2 and aggregate task T3, where aggregate part dependency 320 is a finish-to-start dependency. Aggregate part dependency 320 is displayed within a timeline that is displayed within the user interface. More specifically, an aggregate part dependency indicator is displayed within the user interface, where the aggregate part dependency indicator represents aggregate part dependency 320. In the illustrated embodiment, the aggregate part dependency indicator is a multi-line arrow that connects the aggregate task indicator that represents aggregate task T2 (i.e., the predecessor aggregate task) and the aggregate task indicator that represents aggregate task T3 (i.e., the successor aggregate task), where an arrow head of the multi-line arrow points towards the aggregate task indicator that represents aggregate task T3. Further, aggregate part dependency 320 has a dependency multiplicity of 2-to-1. In other words, every two aggregate parts of aggregate task T2 have a finish-to-start dependency with an aggregate part of aggregate task T3. Thus, a dependency multiplicity indicator is displayed adjacent to a portion of the multi-line arrow that is adjacent or closest to the aggregate task indicator that represents aggregate task T2 (“2” in the illustrated embodiment). Further, a dependency multiplicity indicator is also displayed adjacent to a portion of the multi-line arrow that is adjacent or closest to the aggregate task indicator that represents aggregate task T3 (“1” in the illustrated embodiment). In addition, in the illustrated embodiment, a portion of the multi-line arrow that is adjacent or closest to the aggregate task indicator that represents aggregate task T3 is a dashed multi-line arrow rather than a solid multi-line arrow. This visually indicates that aggregate task T3 has fewer aggregate parts than aggregate task T2, even after considering multiplicity. Additionally, the start date-time of aggregate task T3 has been adjusted by 3 days from November 28 (start-of-day) to December 1 (start-of-day), so that the first aggregate part of aggregate task T3 is scheduled to start on or after a scheduled finish of the first two aggregate parts of aggregate task T2. The adjustment of the start date-time results in aggregate task T3 starting 3 days later than originally scheduled in project plan 33. In certain embodiments, the first aggregate part of aggregate task T3 can start at a date-time that is substantially identical to a date-time that the second aggregate part of aggregate task T2 finishes. Further, because a duration of each set of two aggregate parts of aggregate task T2 (i.e., 2 days) is larger than a duration of each aggregate part of aggregate task T3 (i.e., 0.5 days), idle periods are created within aggregate task T3. These idle periods can be represented within the aggregate task indicator that represents aggregate task T3 by automatically displaying stripe spacing within the aggregate task indicator. In the illustrated embodiment, portions of the aggregate task indicator that represent the idle periods within aggregate task T3 are shaded with dots.

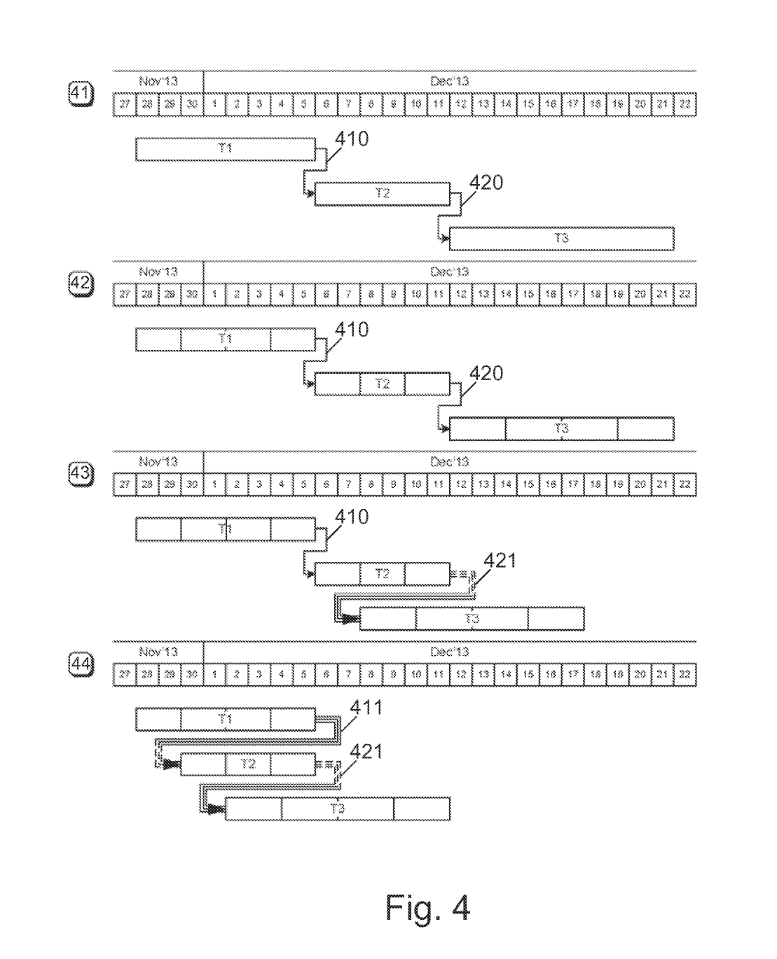

FIG. 4 illustrates a conversion of tasks to aggregate tasks, and a conversion of a task dependency to an aggregate part dependency, according to an embodiment of the invention. More specifically, FIG. 4 illustrates a project plan 41 displayed by an aggregate task system, such as system 10 of FIG. 1. Project plan 41 includes tasks T1, T2, and T3. Tasks T1, T2, and T3 are displayed within a timeline that is displayed within a user interface. More specifically, task indicators (bars in the illustrated embodiment) are displayed within the user interface, where the task indicators represent tasks T1, T2, and T3. Task T1 has a duration of 8 days, a start date-time of November 28 (start-of-day) and a finish date-time of December 5 (end-of-day). Task T2 has a duration of 6 days, a start date-time of December 6 (start-of-day) and a finish date-time of December 11 (end-of-day). Task T3 has a duration of 10 days, a start date-time of December 12 (start-of-day) and a finish date-time of December 21 (end-of-day).

Further, the aggregate task system has defined a task dependency 410 between task T1 and task T2, where task dependency 410 is a finish-to-start dependency. Task dependency 410 is displayed within a timeline that is displayed within the user interface. More specifically, a task dependency indicator is displayed within the user interface, where the task dependency indicator represents task dependency 410. In the illustrated embodiment, the task dependency indicator is a single-line arrow that connects the task indicator that represents task T1 (i.e., the predecessor task) and the task indicator that represents task T2 (i.e., the successor task), where an arrow head of the single-line arrow points towards the task indicator that represents task T2. In addition, the aggregate task system has defined a task dependency 420 between task T2 and task T3, where task dependency 420 is a finish-to-start dependency. Task dependency 420 is displayed within a timeline that is displayed within the user interface. More specifically, a task dependency indicator is displayed within the user interface, where the task dependency indicator represents task dependency 420. In the illustrated embodiment, the task dependency indicator is a single-line arrow that connects the task indicator that represents task T2 (i.e., the predecessor task) and the task indicator that represents task T3 (i.e., the successor task), where an arrow head of the single-line arrow points towards the task indicator that represents task T3.

FIG. 4 further illustrates a project plan 42 displayed by an aggregate task system. Project plan 42 is similar to project plan 41, except that, within project plan 42, the aggregate task system has converted tasks T1, T2, and T3 into aggregate tasks T1, T2, and T3. In certain embodiments, the aggregate task system can convert a task into an aggregate task in response to a user interaction, such as moving a cursor over a task indicator that represents the task, “clicking” on the task indicator, and inputting a number of aggregate parts. As part of the conversion, aggregate task T1 has been partitioned so that aggregate task T1 includes four aggregate parts, aggregate task T2 has been partitioned so that aggregate task T2 includes three aggregate parts, and aggregate task T3 has been partitioned so that aggregate task T3 includes four aggregate parts. Aggregate tasks T1, T2, and T3 are displayed within a timeline that is displayed within a user interface. More specifically, aggregate task indicators (bars with respective dividers in the illustrated embodiment) are displayed within the user interface, where the aggregate task indicators represent aggregate tasks T1, T2, and T3. In certain embodiments, the user can convert tasks T1, T2, and T3 into aggregate tasks T1, T2, and T3 because there is urgency in completing the tasks, and it is desired that the tasks be performed at least partly in parallel.

FIG. 4 further illustrates a project plan 43 displayed by an aggregate task system. Project plan 43 is similar to project plan 42, except that, within project plan 43, the aggregate task system has converted task dependency 420 into aggregate part dependency 421. In certain embodiments, the aggregate task system can convert a task dependency into an aggregate part dependency in response to a user interaction, such as moving a cursor over a task dependency indicator that represents the task dependency, and “clicking” on the task dependency indicator. As part of the conversion, a start date-time of aggregate task T3 is adjusted by 4 days from December 12 (start-of-day) to December 8 (start-of-day). The adjustment of the start date-time results in aggregate task T3 starting 4 days earlier than originally scheduled in project plan 42. This is because a first aggregate part of aggregate task T3 can start at or after a scheduled finish of a first aggregate part of aggregate task T2, rather than waiting for all the aggregate parts of aggregate task T2 to finish. In certain embodiments, the first aggregate part of aggregate task T3 can start at a date-time that is substantially identical to a date-time that the first aggregate part of aggregate task T2 finishes. Thus, some aggregate parts of aggregate tasks T2 and T3 can be performed in parallel.

FIG. 4 further illustrates a project plan 44 displayed by an aggregate task system. Project plan 44 is similar to project plan 43, except that, within project plan 44, the aggregate task system has converted task dependency 410 into aggregate part dependency 411. In certain embodiments, the aggregate task system can convert a task dependency into an aggregate part dependency in response to a user interaction, such as moving a cursor over a task dependency indicator that represents the task dependency, and “clicking” on the task dependency indicator. As part of the conversion, a start date-time of aggregate task T2 is adjusted by 6 days from December 6 (start-of-day) to November 29 (start-of-day). The adjustment of the start date-time results in aggregate task T2 starting 6 days earlier than originally scheduled in project plan 43. This is because a first aggregate part of aggregate task T2 can start at or after a scheduled finish of a first aggregate part of aggregate task T1, rather than waiting for all the aggregate parts of aggregate task T1 to finish. In certain embodiments, the first aggregate part of aggregate task T2 can start at a date-time that is substantially identical to a date-time that the first aggregate part of aggregate task T1 finishes. Thus, some aggregate parts of aggregate tasks T1 and T2 can be performed in parallel. Further, due to the adjustment of the start date-time of aggregate task T2, a start date-time of aggregate task T3 is also adjusted by 6 days from December 8 (start-of-day) to December 2 (start-of-day). The adjustment of the start date-time results in aggregate task T3 starting 6 days earlier than previously scheduled in project plan 43 (and 10 days earlier than originally scheduled in project plan 42).

Thus, according to an embodiment, a project manager can use the aggregate task system to force a sequential set of tasks to be performed, at least in part, in parallel by converting tasks into aggregate tasks, and by converting task dependencies into aggregate task dependencies. The project manager may perform this conversion due to outside factors, such as a compressed project schedule, requiring that tasks of a project be completed earlier than originally planned. This can be done even if the tasks are not true “aggregate tasks,” and have nothing to do with aggregating task parts. The project manager can further convert aggregate tasks back into tasks, and can further convert aggregate part dependencies back into task dependencies.

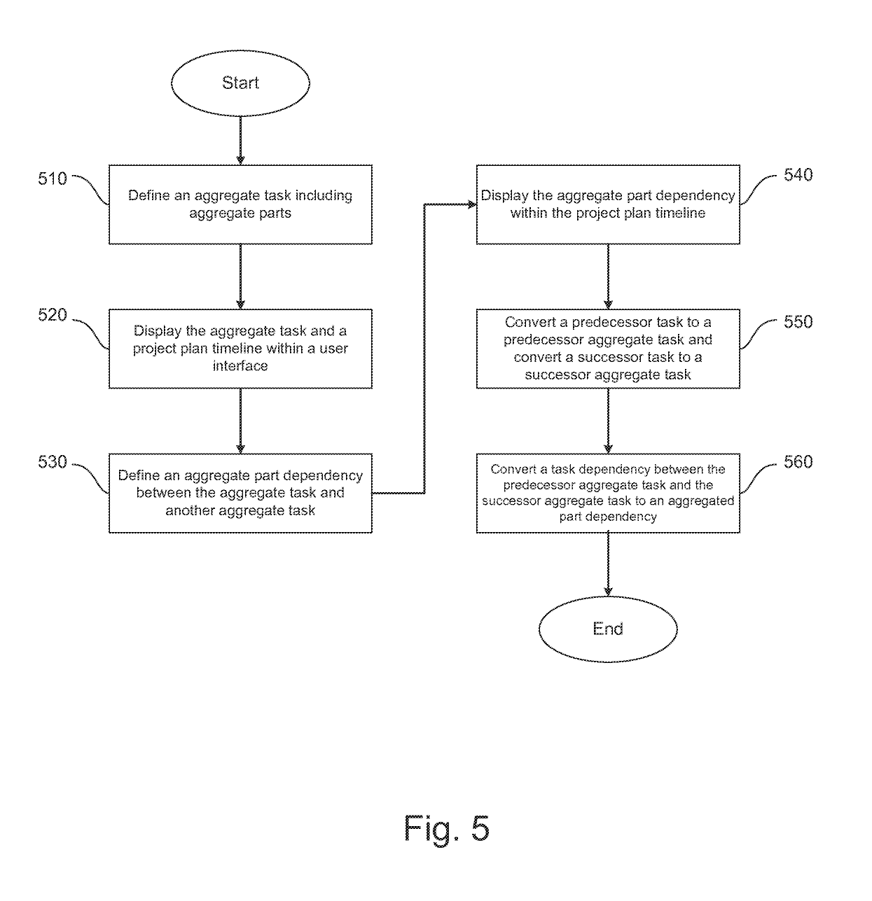

FIG. 5 illustrates a flow diagram of the functionality of an aggregate task module (such as aggregate task module 16 of FIG. 1), according to an embodiment of the invention. In one embodiment, the functionality of the flow diagram of FIG. 5 is implemented by software stored in a memory or some other computer-readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software. In certain embodiments, some of the functionality can be omitted.

The flow begins and proceeds to 510. At 510, an aggregate task is defined, where the aggregate task includes a plurality of aggregate parts. Each aggregate part is an individual task that is part of the aggregate task. Further, the aggregate task defines a sequence of the aggregate parts. The flow then proceeds to 520.

At 520, the aggregate task and a project plan timeline are displayed within a user interface. The aggregate task is displayed within the project plan timeline. Further, the aggregate task is displayed as an aggregate task indicator, where the aggregate task indicator includes a plurality of aggregate part indicators separated by dividers. In certain embodiments, the aggregate task indicator can be a bar, and the aggregate part indicators can be bars as well. The flow then proceeds to 530.

At 530, an aggregate part dependency is defined between the aggregate task and another aggregate task that is displayed within the project plan timeline. The aggregate part dependency defines a dependency between the aggregate parts of the aggregate task and a plurality of aggregate parts of the other aggregate task. In certain embodiments, the aggregate part dependency can be one of: a finish-to-start dependency; a finish-to-finish dependency; a start-to-start dependency; or a start-to-finish dependency. The flow then proceeds to 540.

At 540, the aggregate part dependency is displayed within the project plan timeline. The aggregate part dependency is displayed as an aggregate part dependency indicator that connects the aggregate task indicator that represents the aggregate task and another aggregate task indicator that represents the other aggregate task. In certain embodiments, the aggregate task indicator can be a multi-line arrow. Further, in some of these embodiments, the aggregate task and the other aggregate task can have a different number of aggregate parts. Even further, in some of these embodiments, the aggregate task can have a fewer number of aggregate parts, and a portion of the aggregate part dependency indicator that is closest to the aggregate task indicator can be a dashed multi-lined arrow. Further, in certain embodiments, at least one dependency multiplicity can be defined for at least one portion of the aggregate part dependency, and, in some of these embodiments, at least one dependency multiplicity indicator can be displayed within the project plan timeline. Even further, in some of these embodiments, the aggregate task can have a fewer number of aggregate parts, even after considering dependency multiplicity, and a portion of the aggregate part dependency indicator that is closest to the aggregate task indicator can be a dashed multi-lined arrow. The flow then proceeds to 550.

At 550, a predecessor task is converted to a predecessor aggregate task, and a successor task is converted to a successor aggregate task. The predecessor task and the successor task can be two tasks with a task dependency defined between the two tasks, where the successor task is dependent upon the predecessor task. In certain embodiments, the predecessor task can be converted to the predecessor aggregate task in response to a first user interaction, and the successor task can be converted to the successor aggregate task in response to a second user interaction. The flow then proceeds to 560.

At 560, a task dependency between the aggregate predecessor task and the successor aggregate task is converted to an aggregate part dependency. In certain embodiments, the task dependency can be converted to the aggregate part dependency in response to a third user interaction. Further, in certain embodiments, the aggregate predecessor task and the successor aggregate task can be performed, at least in part, in parallel. More specifically, a start or finish of an aggregate part of the predecessor aggregate task and a start or finish of an aggregate part of the successor aggregate task can occur at a substantially identical date-time. The flow then ends.

Thus, an aggregate task system is provided that can provide the ability to define and easily manage a single entity (i.e., an aggregate task), instead of a large number of similar or identical individual tasks. The aggregate task system can further provide the ability to define and easily manage a single dependency relationship between two aggregate tasks (i.e., an aggregate part dependency), instead of repetitively defining individual dependencies between every pair of individual tasks. Additionally, the aggregate task system can provide the ability to unclutter a project plan by removing smaller individual tasks (i.e., by combining smaller individual tasks into aggregate tasks), and by removing fine-grained dependencies (i.e., by combining fine-grained dependencies into aggregate part dependencies). Even further, the aggregate task system can provide the ability to easily force-covert sequential tasks into quasi-parallel tasks (i.e., by converting tasks into aggregate tasks, and by converting task dependencies into aggregate part dependencies). All these abilities can allow a project manager to more easily define, manage, and track a large number of similar or identical small individually tasks without compromising any other project plan features, such as scheduling features. Further, the aggregate task system can assist a project manager in analyzing and modeling projects where a project duration is variable (i.e., by decreasing duration by forceful parallelism, and by increasing duration by forceful sequentialization).

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A computer-readable medium having instructions stored thereon that, when executed by a processor, cause the processor to manage tasks, the managing comprising:
defining an aggregate task comprising a plurality of aggregate parts, wherein each aggregate part is an individual task that is a part of the aggregate task, and wherein the aggregate task defines a sequence of the aggregate parts; and
displaying the aggregate task and a project plan timeline within a user interface, wherein the aggregate task is displayed within the project plan timeline, and wherein the aggregate task is displayed as an aggregate task indicator comprising a plurality of aggregate part indicators separated by dividers.

2. The computer-readable medium of claim 1, the managing further comprising:
defining an aggregate part dependency between the aggregate task and another aggregate task that is displayed within the project plan timeline, wherein the aggregate part dependency defines a dependency between the aggregate parts of the aggregate task and a plurality of aggregate parts of the other aggregate task; and
displaying the aggregate part dependency within the project plan timeline, wherein the aggregate part dependency is displayed as an aggregate part dependency indicator that connects the aggregate task indicator that represents the aggregate task and another aggregate task indicator that represents the other aggregate task.

3. The computer-readable medium of claim 2, wherein the aggregate part dependency is one of: a finish-to-start dependency; a finish-to-finish dependency; a start-to-start dependency; or a start-to-finish dependency.

4. The computer-readable medium of claim 2, wherein the aggregate part dependency indicator comprises a multi-line arrow.

5. The computer-readable medium of claim 2, wherein the aggregate task and the other aggregate task have a different number of aggregate parts.

6. The computer-readable medium of claim 5, wherein the aggregate task has a fewer number of aggregate parts, and wherein a portion of the aggregate part dependency indicator that is closest to the aggregate task indicator comprises a dashed multi-line arrow.

7. The computer-readable medium of claim 5, wherein at least one dependency multiplicity is defined for at least one portion of the aggregate part dependency.

8. The computer-readable medium of claim 7, wherein at least one dependency multiplicity indicator is displayed within the project plan timeline.

9. The computer-readable medium of claim 2, the managing further comprising:
converting a predecessor task to a predecessor aggregate task and converting a successor task to a successor aggregate task; and
converting a task dependency between the predecessor aggregate task and the successor aggregate task to an aggregated part dependency.

10. The computer-readable medium of claim 9,
wherein the predecessor task is converted to the predecessor aggregate task in response to a first user interaction;
wherein the successor task is converted to the successor aggregate task in response to a second user interaction; and
wherein the task dependency is converted to the aggregate part dependency in response to a third user interaction.

11. The computer-readable medium of claim 9, wherein a start or finish of an aggregate part of the predecessor aggregate task and a start or finish of an aggregate part of the successor aggregate task occur at a substantially identical date-time.

12. The computer-readable medium of claim 1, wherein the aggregate task indicator comprises a bar, and wherein the aggregate part indicators comprise bars.

13. A computer-implemented method for managing tasks, the computer-implemented method comprising:
defining an aggregate task comprising a plurality of aggregate parts, wherein each aggregate part is an individual task that is a part of the aggregate task, and wherein the aggregate task defines a sequence of the aggregate parts; and
displaying the aggregate task and a project plan timeline within a user interface, wherein the aggregate task is displayed within the project plan timeline, and wherein the aggregate task is displayed as an aggregate task indicator comprising a plurality of aggregate part indicators separated by dividers.

14. The computer-implemented method of claim 13, further comprising:
defining an aggregate part dependency between the aggregate task and another aggregate task that is displayed within the project plan timeline, wherein the aggregate part dependency defines a dependency between the aggregate parts of the aggregate task and a plurality of aggregate parts of the other aggregate task; and
displaying the aggregate part dependency within the project plan timeline, wherein the aggregate part dependency is displayed as an aggregate part dependency indicator that connects the aggregate task indicator that represents the aggregate task and another aggregate task indicator that represents the other aggregate task.

15. The computer-implemented method of claim 14, further comprising:
converting a predecessor task to a predecessor aggregate task and converting a successor task to a successor aggregate task; and
converting a task dependency between the predecessor aggregate task and the successor aggregate task to an aggregated part dependency.

16. The computer-implemented method of claim 15, wherein a start or finish of an aggregate part of the predecessor aggregate task and a start or finish of an aggregate part of the successor aggregate task occur at a substantially identical date-time.

17. A system for managing tasks, the system comprising:
an aggregate task definition module configured to define an aggregate task comprising a plurality of aggregate parts, wherein each aggregate part is an individual task that is a part of the aggregate task, and wherein the aggregate task defines a sequence of the aggregate parts; and
an aggregate task display module configured to display the aggregate task and a project plan timeline within a user interface, wherein the aggregate task is displayed within the project plan timeline, and wherein the aggregate task is displayed as an aggregate task indicator comprising a plurality of aggregate part indicators separated by dividers.

18. The system of claim 17, further comprising:
an aggregate part dependency definition module configured to define an aggregate part dependency between the aggregate task and another aggregate task that is displayed within the project plan timeline, wherein the aggregate part dependency defines a dependency between the aggregate parts of the aggregate task and a plurality of aggregate parts of the other aggregate task; and
an aggregate part dependency display module configured to display the aggregate part dependency within the project plan timeline, wherein the aggregate part dependency is displayed as an aggregate part dependency indicator that connects the aggregate task indicator that represents the aggregate task and another aggregate task indicator that represents the other aggregate task.

19. The system of claim 18, further comprising:
a task conversion module configured to convert a predecessor task to a predecessor aggregate task, and further configured to convert a successor task to a successor aggregate task; and
a task dependency conversion module configured to convert a task dependency between the predecessor aggregate task and the successor aggregate task to an aggregated part dependency.

20. The system of claim 19, wherein a start or finish of an aggregate part of the predecessor aggregate task and a start or finish of an aggregate part of the successor aggregate task occur at a substantially identical date-time.
